(19) United States
(12) Patent Application Publication
(10) Pub. No.: US 2026/0155310 A1
(43) Pub. Date: Jun. 4, 2026

(54) MULTILAYER ELECTRONIC COMPONENT

(71) Applicant: SAMSUNG ELECTRO-MECHANICS CO., LTD., Suwon-si (KR)

(72) Inventors: Jin Sung CHUN, Suwon-si (KR); Min Hoe KIM, Suwon-si (KR); Yong Gyu HAN, Suwon-si (KR); Wi Hun KIM, Suwon-si (KR)

(73) Assignee: SAMSUNG ELECTRO-MECHANICS CO., LTD., Suwon-si (KR)

(21) Appl. No.: 19/322,411

(22) Filed: Sep. 8, 2025

(30) Foreign Application Priority Data
Nov. 29, 2024 (KR) 10-2024-0175512

(51) Int. Cl. H01G 4/30; H01G 4/232

(52) U.S. Cl. CPC H01G 4/30; H01G 4/2325

(57) ABSTRACT

A multilayer electronic component according to an example embodiment of the present disclosure may include: a body including a dielectric layer and internal electrodes alternately disposed with the dielectric layer in a first direction, and including first and second surfaces opposing each other in the first direction, third and fourth surfaces connected to the first and second surfaces and opposing each other in a second direction, and fifth and sixth surfaces connected to the first to fourth surfaces and opposing each other in a third direction; a protrusion portion disposed on the first and second surfaces; and an external electrode disposed on the third and fourth surfaces, wherein a width of the body in the third direction is W and a width of the protrusion portion in the third direction is W1, W1/W may be 0.5 or more and 0.85 or less.

### CROSS-REFERENCE TO RELATED APPLICATION(S)

This application claims benefit of priority to Korean Patent Application No. 10-2024-0175512 filed on Nov. 29, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic products, such as image display devices, including a liquid crystal display LCD and a plasma display panel PDP, computers, smartphones and mobile phones, and serves to charge or discharge electricity therein or therefrom.

MLCCs used in high-voltage environments are called high-voltage MLCCs and have a rated voltage of 100 V or higher. Since high-voltage MLCCs have significantly higher rated voltages than general MLCCs, a relatively higher voltage may be applied thereto, as compared to general MLCCs in high-temperature acceleration evaluations and moisture-resistant reliability evaluations.

When voltage is applied to the MLCC, a volume thereof expands and contracts repeatedly, due to an electrostriction phenomenon of a dielectric, which is a unique characteristic of ferroelectric ceramic materials, and cracks may occur between internal electrodes and the dielectric due to insufficient bonding force, which may reduce reliability.

In general, a volume expansion within a capacitance formation portion is driven while maintaining a shape of the MLCC by resisting deformation of a cover portion disposed on the capacitance formation portion. However, in high-voltage MLCCs, since the applied voltage is high, the expansion/contraction rate increases, and a fixing force of the cover portion alone may not be sufficient. Therefore, there is a need for the development of MLCCs that can suppress volume expansion caused by electrostriction and increase deformation resistance caused by electrostriction.

### SUMMARY

An aspect of the present disclosure is to provide a multilayer electronic component having excellent reliability.

Another aspect of the present disclosure is to provide a multilayer electronic component in which crack occurrence is suppressed.

Another aspect of the present disclosure is to provide the multilayer electronic component having improved resistance to deformation caused by electrostriction.

However, the purpose of the present disclosure is not limited to the above-described content, and may be more easily understood in the process of explaining specific embodiments of the present disclosure.

A multilayer electronic component according to an embodiment of the present disclosure may include: a body including a dielectric layer and internal electrodes alternately disposed with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; protrusion portions disposed on the first and second surfaces; and external electrodes disposed on the third and fourth surfaces, wherein a width of the body in the third direction is W, a width of the protrusion portion in the third direction is W1, and W1/W may be 0.5 or more and 0.85 or less.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment of the present disclosure.

FIG. 2 schematically illustrates a cross-sectional view taken along line I-I′ of FIG. 1.

FIG. 3 schematically illustrates a cross-sectional view taken along line II-II′ of FIG. 1.

FIG. 4 schematically illustrates a body and protrusion portion disassembled.

FIG. 5 is a graph illustrating a width of the protrusion portion according to W1/W.

FIG. 6 is a graph illustrating a stress according to W1/W.

FIG. 7 is a graph illustrating a displacement according to W1/W.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawing, an X direction may be defined as a first direction, a stacking direction or a thickness direction T, a Y direction may be defined as a second direction or a length direction L, and a Z direction may be defined as a third direction or a width direction W.

### Multilayer Electronic Component

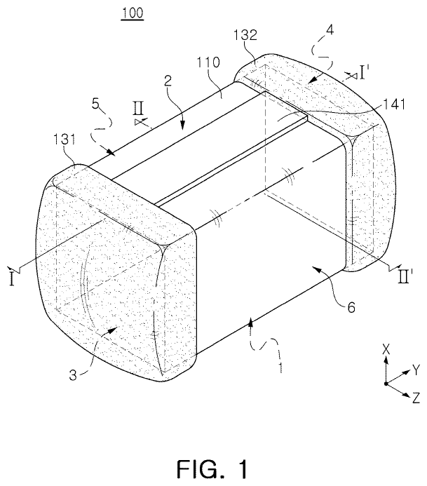

FIG. 1 schematically illustrates a perspective view of a multilayer electronic component according to an embodiment of the present disclosure.

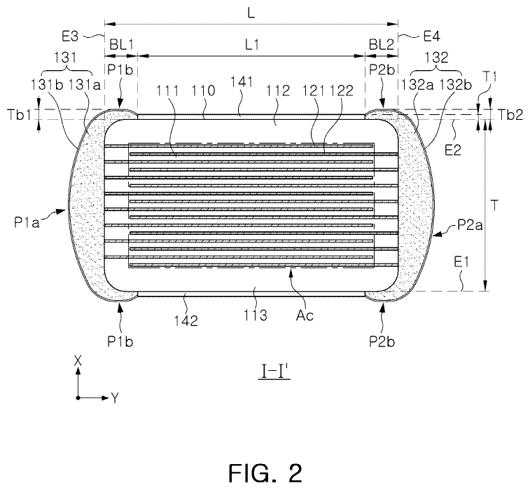

FIG. 2 schematically illustrates a cross-sectional view taken along line I-I′ of FIG. 1.

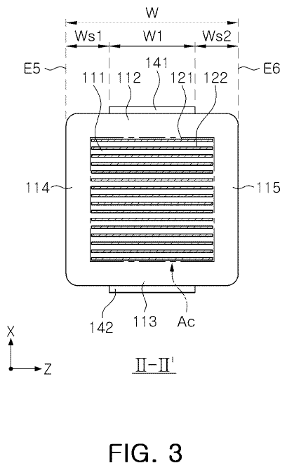

FIG. 3 schematically illustrates a cross-sectional view taken along line II-II′ of FIG. 1.

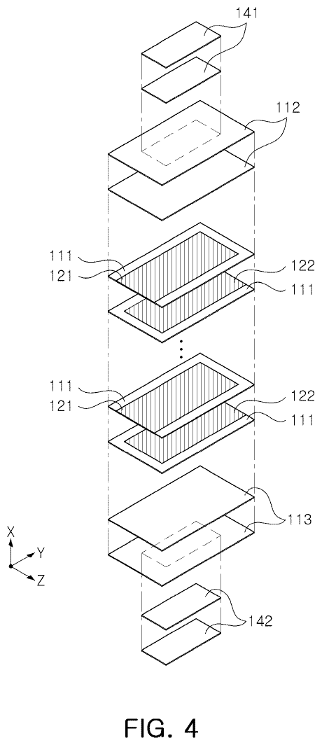

FIG. 4 schematically illustrates a body and protrusion portion disassembled.

Hereinafter, a multilayer electronic component 100 according to an embodiment of the present disclosure will be described in detail with reference to FIGS. 1 to 4. In addition, as an example of a multilayer electronic component, a multilayer ceramic capacitor (hereinafter referred to as ‘MLCC’) is described, but the present disclosure is not limited thereto and may also be applied to various multilayer electronic components using ceramic materials, such as inductors, piezoelectric elements, varistors, or thermistors.

According to an embodiment of the present disclosure, a multilayer electronic component 100 may include: a body 110 including a dielectric layer 111 and internal electrodes 121 and 122 disposed alternately with the dielectric layer 111 in a first direction, the body having first and second surfaces 1 and 2 opposing each other in the first direction, third and fourth surfaces 3 and 4 connected to the first and second surfaces 1 and 2 and opposing each other in a second direction, and fifth and sixth surfaces 5 and 6 connected to the first to fourth surfaces and opposing each other in a third direction; protrusion portions 141 and 142 disposed on the first and second surfaces; and external electrodes 131 and 132 disposed on the third and fourth surfaces, wherein a width of the body in a third direction is W and a width of the protrusion portions in a third direction is W1, W1/W may be 0.5 or more and 0.85 or less.

When voltage is applied to the MLCC, a volume expands and contracts repeatedly due to an electrostriction phenomenon of a dielectric, which is a unique characteristic of ferroelectric ceramic materials, and cracks may occur between internal electrodes and the dielectric due to insufficient bonding force, which may reduce reliability.

In order to suppress volume expansion within the capacitance formation portion caused by the electrostriction phenomenon, a cover portion is disposed on the capacitance formation portion, but the fixing force may not be sufficient just by resisting deformation of the cover portion. Accordingly, in the present disclosure, protrusion portions 141 and 142 may be disposed on the first and second surfaces 1 and 2 of the body to suppress volume expansion caused by electrostriction and increase deformation resistance caused by electrostriction.

Hereinafter, each component included in the multilayer electronic component 100 according to an embodiment of the present disclosure will be described.

The body 110 may have a dielectric layer 111 and the internal electrodes 121 and 122, alternately stacked therein.

The body 110 is not limited to a particular shape, and may have a hexahedral shape or a shape similar to the hexahedral shape, as illustrated in the drawings. The body 110 may not have a hexahedral shape having perfectly straight lines because ceramic powder particles included in the body 110 may contract in a process in which the body is sintered. However, the body 110 may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first and second surfaces 1 and 2, connected to the third and fourth surfaces 3 and 4, and opposing each other in the third direction.

As a margin region where the internal electrodes 121 and 122 are not disposed on the dielectric layer 111, a step difference may occur due to the thickness of the internal electrodes 121 and 122, the corner connecting the first surface and the third to fifth surfaces and/or the corner connecting the second surface and the third to fifth surfaces may have a contracted form toward the center of the body 110 in the first direction when viewed based on the first surface or the second surface. Alternatively, due to the contraction behavior during the sintering process of the body, a corner connecting the first surface 1 and the third to sixth surfaces 3,4,5,6 and/or a corner connecting the second surface 2 and the third to sixth surfaces 3,4,5,6 may have a form contracting toward the center of the body 110 in the first direction when viewed with based on the first surface or the second surface. Alternatively, to prevent chipping defects, or like, the corners connecting each surface of the body 110 may be rounded by performing an additional process, in which the corners connecting the first surface and the third to sixth surfaces and/or the corners connecting the second surface and the third to sixth surfaces may have a rounded form.

Meanwhile, in order to suppress the step difference caused by the internal electrodes 121 and 122, after stacking, the internal electrodes are cut so that they are exposed to the fifth and sixth surfaces 5 and 6 of the body, and then when a single dielectric layer or two or more dielectric layers are stacked in the third direction (width direction) on both surfaces of the capacitance formation portion Ac to form the margin portions 114 and 115, the portion connecting the first surface and the fifth and sixth surfaces and the portion connecting the second surface and the fifth and sixth surfaces may not have a contracted form.

A plurality of dielectric layers 111 forming the body 110 may be in a sintered state, and adjacent dielectric layers 111 may be integrated with each other, such that boundaries therebetween may not be readily apparent without a scanning electron microscope (SEM). The number of dielectric layers is not particularly limited and it may be determined in consideration of a size of the multilayer electronic component. For example, a body may be formed by stacking more than 400 layers of genetic layers.

The dielectric layer 111 may be formed by preparing a ceramic slurry including ceramic powder, organic solvents, and binder, applying and drying the slurry on a carrier film to prepare a ceramic green sheet, and then sintering the ceramic green sheet. The ceramic powder is not particularly limited as long as sufficient electrostatic capacitance may be obtained, but for example, barium titanate (BaTiO₃)-based powder may be used as the ceramic powder. For a more specific example, the ceramic powder may be one or more of BaTiO3, (Ba1−xCax)TiO3 (0<x<1), Ba(Ti1−yCay)O3 (0<y<1), (Ba1−xCax) (Ti1−yZry)O3 (0<x<1, 0<y<1) and Ba(Ti1−yZry)O3 (0<y<1).

An average thickness td of the dielectric layer 111 is not particularly limited, but for example, in the case of a high-voltage MLCC, the average thickness td of the dielectric layer may be 3 to 20 μm. However, it is not limited thereto, and the average thickness td of the dielectric layer 111 may be arbitrarily set according to desired characteristics or purpose.

In this case, the average thickness td of the dielectric layer 111 refers to a size of the dielectric layer 111 disposed between the internal electrodes 121 and 122 in the first direction. The average thickness of the dielectric layer 111 may be measured by scanning a cross-sections of the body 110 in the first and second direction with a scanning electron microscope SEM of 10,000× magnification. More specifically, the average value may be measured by calculating the thickness at a plurality of points of one dielectric layer 111, for example, at 30 points equally spaced apart from each other in the second direction, and then taking the average value. The 30 points which are equally spaced apart, may be designated in the capacitance formation portion Ac to be described later. In addition, when measuring the average value measurement is expanded to 10 dielectric layers 111 to calculate the average value, the average thickness of the dielectric layer 111 may be further generalized.

The body 110 may include the capacitance formation portion Ac, in which dielectric layers 111 and internal electrodes 121 and 122 may be alternately disposed in the first direction, and cover portions 112 and 113 disposed on upper and lower portions of the capacitance formation portion in the first direction.

The capacitance formation portion Ac may be disposed inside the body 110 and capacitance may be formed by including a first internal electrode 121 and a second internal electrode 122 disposed opposing each other with the dielectric layer 111 therebetween.

In addition, the capacitance formation portion Ac is a portion that contributes to the capacitance formation of the capacitor, and may be formed by repeatedly stacking a plurality of first and second internal electrodes 121 and 122 with the dielectric layer 111 therebetween.

Cover portions 112 and 113 may include an upper cover portion 112 disposed on an upper portion of the capacitance formation part Ac in the first direction and a lower cover portion 113 disposed on a lower portion of the capacitance formation portion Ac in the first direction.

The upper cover portion 112 and the lower cover portion 113 may be formed by stacking a single dielectric layer or two or more dielectric layers on upper and lower surfaces of the capacitance formation portion Ac in a thickness direction, respectively, and the upper cover portion 112 and the lower cover portion 113 may contribute to basically prevent damage to the internal electrodes due to physical or chemical stress.

The upper cover portion 112 and the lower cover portion 113 may not include internal electrodes, and may include the same material as that of the dielectric layer 111.

That is, the upper cover portion 112 and the lower cover portion 113 may include a ceramic material, for example, a barium titanate (BaTiO₃)-based ceramic material.

Meanwhile, the thickness of the cover portions 112 and 113 is not particularly limited. However, in order to more effectively suppress the electrostriction phenomenon, the thickness tc of the cover portions 112 and 113 may be 200 to 350 μm.

The average thickness tc of the cover portions 112 and 113 may mean a size in the first direction, and may be an average value of a size of the cover portions 112 and 113 in the first direction measured at 5 equally spaced apart points on the upper and lower portions of the capacitance formation portion Ac.

In addition, margin portions 114 and 115 may be disposed on a side surface of the capacitance formation portion Ac. The margin portions 114 and 115 may include a first margin portion 114 disposed on the fifth surface 5 of the body 110 and a second margin portion 115 disposed on the sixth surface 6 thereof. That is, the margin portions 114 and 115 may be disposed on both end surfaces of the body 110 in a width direction.

As illustrated in FIG. 3, the margin portions 114 and 115 may refer to a region between the two ends of the first and second internal electrodes 121 and 122 and a boundary surface of the body 110 in a cross-section of the body 110 in a width-thickness (W-T) direction.

The margin portions 114 and 115 may basically contribute to prevent damage to the internal electrodes due to physical or chemical stresses.

The margin portions 114 and 115 may be formed by forming an internal electrodes by applying a conductive paste to a ceramic green sheet, except for a region where the margin portion is to be formed.

In addition, to suppress a step difference caused by the internal electrodes 121 and 122, after stacking, the internal electrodes may be cut so that they are exposed to the fifth and sixth surfaces 5 and 6 of the body, and then a single dielectric layer or two or more dielectric layers may be stacked in the third direction (width direction) on both surfaces of the capacitance formation portion Ac to form the margin portions 114 and 115.

Meanwhile, a width of the margin portions 114 and 115 is particularly limited. However, in order to more easily achieve miniaturization and high capacitance of the multilayer electronic component, an average width of the margin portions 114 and 115 may be 180 to 350 μm.

The average width of the margin portions 114 and 115 may refer to an average size MW1 of a region where the internal electrodes is spaced apart from the fifth surface in the third direction and an average size MW2 of a region where the internal electrodes is spaced apart from the sixth surface in the third direction, and may be an average value of a size of the margin portions 114 and 115 in the third direction measured at 5 points equally spaced on the side surface of the capacitance formation portion Ac.

Therefore, in an embodiment, the average sizes MW1 and MW2 of the regions spaced apart from the fifth and sixth surfaces of the internal electrodes 121 and 122 in the third direction, may be 180 to 600 μm, respectively.

The internal electrodes 121 and 122 may include first and second internal electrodes 121 and 122. The first and second internal electrodes 121 and 122 may be alternately disposed to oppose each other with the dielectric layer 111 forming the body 110 interposed therebetween, and may be exposed to the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body and connected to the first internal electrode 121, and a second external electrode 132 may be disposed on the fourth surface 4 of the body and connected to the second internal electrode 122.

That is, the first internal electrode 121 is connected to the first external electrode 131, not connected to the second external electrode 132, and the second internal electrode 122 is connected to the second external electrode 132, not connected to the first external electrode 131. Accordingly, the first internal electrode 121 may be formed at a certain distance from the fourth surface 4, and the second internal electrode 122 may be formed at a certain distance from the third surface 3. Additionally, the first and second internal electrodes 121 and 122 may be disposed spaced apart from the fifth and sixth surfaces of the body 110.

The conductive metal included in the internal electrodes 121 and 122 may be one or more of Ni, Cu, Pd, Ag, Au, Pt, In, Sn, Al, Ti, and alloys thereof, but the present disclosure is not limited thereto.

A method of forming the internal electrodes 121 and 122 is not particularly limited. For example, the internal electrodes 121 and 122 may be formed by applying and sintering a conductive paste for internal electrodes including conductive metal on the ceramic green sheet. An application method for the conductive paste for internal electrodes may use a screen printing method or a gravure printing method, but the present disclosure is not limited thereto.

As another example, the internal electrodes 121 and 122 may be formed using a sputtering method, a vacuum deposition method, and/or a chemical vapor deposition method.

An average thickness te of the internal electrodes is not particularly limited. In this case, a thickness of the internal electrodes 121 and 122 may mean a size of the internal electrodes 121 and 122 in the first direction. For example, the average thickness te of the internal electrodes 121 and 122 may be 0.8 to 1.2 μm.

In this case, the average thickness te of the internal electrodes may be measured by scanning a cross-sections of the body 110 in the first and second direction with a scanning electron microscope SEM of 10,000× magnification. More specifically, the average value may be measured by calculating the thickness at a plurality of points of one internal electrodes 121 and 122, for example, at 30 points equally spaced apart from each other in the second direction, and then taking the average value. The 30 points which are equally spaced apart, may be designated in the capacitance formation section Ac. In addition, when measuring the average value measurement expanded to 10 internal electrodes 121 and 122, the average value of the internal electrodes 121 and 122 may be further generalized.

The protrusion portions 141 and 142 may be disposed on the first and second surfaces 1 and 2 of the body 110.

When voltage is applied to the MLCC, the volume expands and contracts repeatedly due to the electrostriction phenomenon of the dielectric, which is a unique characteristic of ferroelectric ceramic materials, and volume expansion and contraction may occur in the dielectric layer disposed in a region where the internal electrodes overlap. In this case, the external electrodes disposed on the third and fourth surfaces of the body acts as clamp fixing both ends of the body in the longitudinal direction, and a electrostriction stress may be concentrated on the first and second surfaces 1 and 2 of the body opposing each other in the stacking direction (first direction, Z direction) of the internal electrodes 121 and 122 and the dielectric layer 111. In the case where only the cover portion is disposed on the upper and lower portions of the capacitance formation portion Ac in the first direction according to the general structure of the MLCC, the resistance that can suppress deformation due to electrostriction is small, so that the first and second surfaces 1 and 2 of the body may have a free expansion structure.

According to an embodiment of the present disclosure, since the protrusion portions 141 and 142 may be disposed on the first and second surfaces 1 and 2 of the body, the resistance may be generated in an opposite direction to the direction in which electrostriction deformation occurs, thereby suppressing deformation caused by electrostriction. Accordingly, cracks may be prevented from occurring between the internal electrode and the dielectric layer, withstand voltage may be improved, and a failure rate may be improved.

In addition, the protrusion portions 141 and 142 may increase a moisture-penetration path and improve moisture-resistance reliability.

According to an embodiment of the present disclosure, when a width of the body 110 in the third direction is W and a width of the protrusion portion in the third direction is W1, W1/W may be 0.5 or more and 0.85 or less. Accordingly, electrostriction stress may be effectively suppressed to prevent cracks from occurring between the internal electrode and the dielectric layer, and the withstand voltage may be improved.

When W1/W is less than 0.5, an effect of suppressing the electrostriction stress by the protrusion portion may be insufficient.

When W1/W exceeds 0.85, there is a concern that the electrostriction stress suppression effect may decrease rapidly or a chip size may increase. Therefore, it is desirable that W1/W is 0.85 or less, and to further improve the stress suppression effect, W1/W may be 0.75 or less. In an embodiment, W1/W may be 0.5 or more and 0.75 or less. W1 and W may be measured by a scanning electron microscope (SEM). Other methods and/or tools appreciated by one of ordinary skill in the art, even if not described in the present disclosure, may also be used.

In an embodiment, when a length of the body 110 in the second direction is L and a length of the protrusion portions 141 and 142 in the second direction is L1, L1/L may be 0.5 or more and 0.8 or less.

When L1/L is less than 0.5, the electrostriction stress suppression effect caused by the protrusion portions may be insufficient, and when it exceeds 0.8, there is a concern that a band portion of the external electrode may become shorter or a chip size may increase.

The length L of the body may be a length from an extension line E3 of the third surface to an extension line E4 of the fourth surface in the second direction. A thickness T of the body 110 may be a thickness from an extension line E1 of the first surface to an extension line E2 of the second surface in the first direction. A width W of the body 110 may be a width from an extension line E5 of the fifth surface to an extension line E6 of the sixth surface in the third direction.

Hereinafter, a description of protrusion portion 141 disposed on the second surface will be mainly described, but since the protrusion portion 142 disposed on the first surface is symmetrical in the X direction with respect to the protrusion portion 141 disposed on the second surface, the same may also be applied to the protrusion portion 142 disposed on the first surface.

In an embodiment, when an average thickness of the protrusion portion 141 in the first direction disposed on the second surface of the body 110 is T1, T1 may be 10 μm or more. When T1 is less than 10 μm, the electrostriction stress suppression effect by the protrusion portion may be insufficient.

The average thickness T1 of the protrusion portion 141 in the first direction may be an average value of a thicknesses in the first direction measured at 10 random points of the protrusion portion on cross-sections in the first and second direction.

In another embodiment, the protrusion portions 141 and 142 and the dielectric layer 111 may include the same main component. Since the protrusion portions 141 and 142 and the dielectric layer 111 include the same main component, the bonding force between the body and the protrusion portions may be improved, and they may be manufactured by sintering at the same time.

The main components included in the protrusion portions 141 and 142 and the dielectric layer 111 may be one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1). In this case, the main component may mean that the content of the main component among the total components is 90 wt % or more.

However, it is not limited thereto, and the protrusion portions 141 and 142 may be formed using a material having electrically insulating characteristics.

The method of forming the protrusion portions 141 and 142 does not particularly limited. Referring to FIG. 4, which schematically illustrates the body and the protrusion portions in a disassembled state, a plurality of dielectric sheets satisfying the width and length of the protrusion portions may be stacked on the cover portions 112 and 113 to form the protrusion portions 141 and 142.

The external electrodes 131 and 132 may be disposed on the third and fourth surfaces. The external electrodes 131 and 132 may be disposed on the third and fourth surfaces 3 and 4 of the body 110, respectively, and may include first and second external electrodes 131 and 132 connected to the first and second internal electrodes 121 and 122, respectively. Additionally, the first and second external electrodes may be disposed to extend to portions of the first and second surfaces.

In addition, the external electrodes 131 and 132 may be disposed to cover both cross-sections of the margin portions 114 and 115 in the second direction.

Meanwhile, in the embodiment, a structure in which the multilayer electronic component 100 has two external electrodes 131 and 132 is described, but the number or shape of the external electrodes 131 and 132 may be changed depending on a shape of the internal electrodes 121 and 122 or other purposes.

Referring to FIG. 2, the external electrodes 131 and 132 may include the first external electrode 131 and the second external electrode 132, the first external electrode may include a first connection portion P1a disposed on the third surface and a first band portion P1b extended from the first connection portion to portions of the first and second surfaces, and the second external electrode may include a second connection portion P2a disposed on the fourth surface and a second band portion P2b extended from the second connection portion to portions of the first and second surfaces.

In an embodiment, when a maximum thickness of the first band portion P1b disposed on the second surface in the first direction is Tb1, a maximum thickness of the second band portion disposed on the second surface in the first direction is Tb2, and an average thickness of the protrusion 141 disposed on the second surface in the first direction is T1, T1≤Tb1 and T1≤Tb2 may be satisfied.

When T1 is thicker than Tb1 and/or Tb2, increasing a chip size may be concerned.

Tb1 may be a thickness from the extension line E2 of the second surface in the first direction to a highest point of the first band portion P1b in the first direction, and Tb2 may be a thickness from the extension line E2 of the second surface in the first direction to a highest point of the second band portion P2b in the first direction. T1, Tb1, and Tb2, and W may be measured by a scanning electron microscope (SEM). Other methods and/or tools appreciated by one of ordinary skill in the art, even if not described in the present disclosure, may also be used.

In an embodiment, when a length of the first band portion P1b disposed on the second surface in the second direction is BL1, a length of the second band portion P2b disposed on the second surface in the second direction is BL2, a length of the protrusion portion 141 disposed on the second surface in the second direction is L1, and a length of the body 110 in the second direction is L, L=L1+BL1+BL2 may be satisfied. That is, an end portion of the band portion P1b of the first external electrode may be in contact with one end of the protrusion portion 141 in the second direction, and the end of the band portion P2b of the second external electrode may be in contact with the other end of the protrusion portion 141 in the second direction.

BL1 may be a length from an extension line E3 of the third surface to the end of the first band portion P1b disposed on the second surface in the second direction, and BL2 may be a length from an extension line E4 of the fourth surface to the end of the second band portion P2b disposed on the second surface in the second direction. L, L1, BL1, and BL2 may be measured by a scanning electron microscope (SEM). Other methods and/or tools appreciated by one of ordinary skill in the art, even if not described in the present disclosure, may also be used.

In an embodiment, the external electrodes 131 and 132 may include electrode layers 131a and 132a disposed to be in contact with the body 110 and plating layers 131b and 132b disposed on the electrode layer, and the electrode layers 131a and 132a may be disposed to be in direct contact with both end surfaces of the protrusion portions 141 and 142 in the second direction.

In an embodiment, the electrode layers 131a and 132a may be disposed to cover a portion of the protrusion portions 141 and 142. That is, the electrode layers 131a and 132a may cover a portion of an upper surface of the protrusion portion 141 disposed on the second surface in the first direction and a portion of a lower surface of the protrusion portion 142 disposed on the first surface in the first direction.

In another embodiment, when a width from the fifth surface of the body 110 to the protrusion portions 141 and 142 in the third direction is Ws1 and a width from the sixth surface of the body 110 to the protrusion portions 141 and 142 in the third direction is Ws2, Ws1≥0.075 W and Ws2≥0.075 W may be satisfied.

When Ws1<0.075 W and/or Ws2<0.075 W, there is a concern that the electrostriction stress suppression effect may decrease rapidly or a chip size may increase.

More preferably, in order to further enhance the electrostriction stress suppression effect, W, Ws1 and Ws2 may satisfy Ws1≥0.125 W and Ws2≥0.125 W. Ws1 and Ws2 may be measured by a scanning electron microscope (SEM). Other methods and/or tools appreciated by one of ordinary skill in the art, even if not described in the present disclosure, may also be used.

Meanwhile, the external electrodes 131 and 132 may be formed using any material as long as they have electrical conductivity, such as a metal, and specific materials may be determined in consideration of electrical characteristics, structural stability, or the like, and further may have a multilayer structure.

For example, the external electrodes 131 and 132 may include the electrode layers 131a and 132a disposed on the body 110 and the plating layers 131b and 132b formed on the electrode layers 131a and 132a.

For a more specific example of the electrode layers 131a and 132a, the electrode layers 131a and 132a may be sintered electrodes including a conductive metal and a glass, or a resin-based electrode including a conductive metal and a resin. A material having excellent electrical conductivity may be used as the conductive metal included in the electrode layers 131a and 132a, but is not particularly limited thereto. For example, the conductive metal may be one or more of nickel (Ni), copper (Cu) and alloys thereof.

In an embodiment, the external electrodes 131 and 132 may be in contact with the internal electrodes 121 and 122 and may include the electrode layers 131a and 132a including Cu and a glass and the plating layers 131b and 132b disposed on the electrode layers.

In addition, the electrode layers 131a and 132a may be have a form in which the fired electrode and the resin-based electrode are sequentially formed on the body. In an embodiment, the electrode layers 131a and 132a may be in contact with the internal electrodes 121 and 122 and may include a base electrode layer including Cu and a glass and a conductive resin layer disposed on the base electrode layer and including a conductive metal and a resin.

In addition, the electrode layers 131a and 132a may be formed by transferring a sheet including the conductive metal on the body, or may be formed by transferring the sheet including the conductive metal to the fired electrode.

The plating layers 131b and 132b may contribute to improve mounting characteristics. A type of the plating layers 131b and 132b is not particularly limited, may be plating layers including one or more of Ni, Sn, Pd, and alloys thereof, and may be formed of a plurality of layers.

For a more specific example of the plating layers 131b and 132b, the plating layers 131b and 132b may be a Ni plating layer or a Sn plating layer, and may be in a form in which a Ni plating layer and a Sn plating layer are sequentially formed on the electrode layers 131a and 132a, or may be in a form in which a Sn plating layer, a Ni plating layer, and a Sn plating layer are sequentially formed. Additionally, the plating layers 131b and 132b may include a plurality of Ni plating layers and/or a plurality of Sn plating layers.

A size of the multilayer electronic component 100 does not particularly need to be limited.

However, since the volume expansion and contraction due to the electrostriction phenomenon increases in a medium-high pressure usage environment, the electrostriction stress suppression effect according to the protrusion portion of the present disclosure may be more significant in the multilayer electronic component 100 having a size of 3216 (length×width, 3.2 mm×1.6 mm) or more.

Accordingly, a maximum size of the multilayer electronic component 100 in the second direction may be 3.2 mm or more, and a maximum size in the third direction may be 1.6 mm or more.

In an embodiment, the rated voltage of the multilayer electronic component 100 may be 100 V or higher. Since the electrostriction stress becomes greater under the high voltage of 100 V or more, the electrostriction stress suppression effect according to the protrusion portion of the present disclosure may be more effective.

### EXAMPLE

In order to verify the electrostriction stress suppression effect according to a width of the protrusion portion, sample chips with different widths of the protrusion portion were prepared.

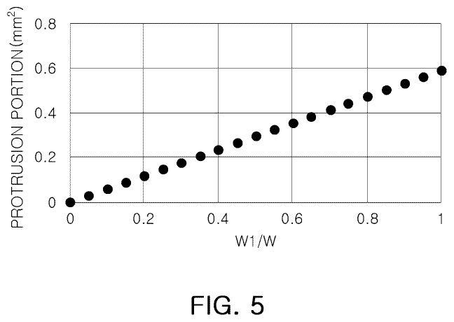

The protrusion area, stress, and displacement according to W1/W (a width of the protrusion portion/a width of the body) of each sample chip are illustrated in FIGS. 5 to 7, respectively.

Referring to FIGS. 2 and 3, the sample chips may be manufactured so that the length L of the body is 3 mm, the thickness T of the body is 4 mm, the length L1 of the protrusion portion is 2 mm, and the average thickness T1 of the protrusion portions is 0.1 mm.

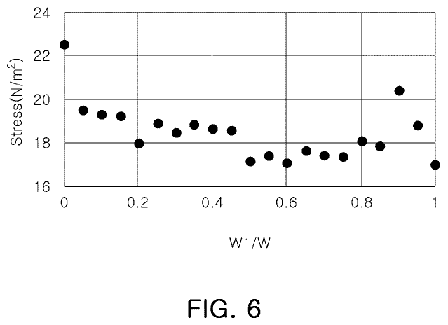

In FIG. 6, the stress refers to a size of force generated by electrostriction when a voltage of 1 V is applied to the sample chip, and may be measured based on Hooke's law.

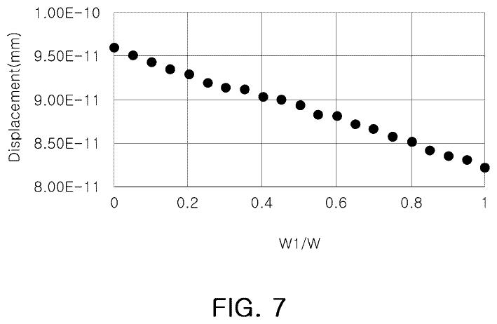

In FIG. 7, displacement refers to a degree of deformation caused by electrostriction and may be measured based on Hooke's law.

Referring to FIG. 5, it may be confirmed that the area of the protrusion portion may increase linearly as W1/W (a width of the protrusion/a width of the body) increases because the length L1 of the protrusion portion and the average thickness T1 of the protrusion portion of each sample chip may be the same.

Referring to FIG. 6, the stress may be measured to be 22.5 N/m² when protrusion portion are not disposed, but when protrusions are disposed, it may be confirmed that the stress may be 20.0 N/m² or less, except when W1/W is 0.90. In particular, when W1/W presented in the present disclosure satisfies 0.5 or more and 0.85 or less, it may be confirmed that the stress is significantly reduced to 18.0 N/m² or less compared to when no protrusion portion is disposed. As the W1/W of the protrusion increases, the stress decreases, but when W1/W is 0.90 or more, the chip size may increase, and when W1/W is 0.90, there may be a region where the stress increases rapidly, so that it may be desirable to satisfy W1/W of 0.5 or more and 0.85 or less. Additionally, in order to reliably control the stress to less than 18.0 N/m², it may be more desirable that W1/W satisfies 0.5 or more and 0.75 or less.

Referring to FIG. 7, it may be confirmed that the displacement decreases almost linearly as W1/W (a width of protrusion/a width of body) increases.

As one of many effects of the present invention, by disposing protrusions on the first and second surfaces of the body, the deformation resistance due to electrostriction of the multilayer electronic component may be improved.

Although the embodiments of the present disclosure have been described in detail above, the present disclosure is not limited by the above-described embodiments and the accompanying drawings, and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While example embodiments have been shown and described above, it will be apparent to those skilled in the art that modifications and variations could be made without departing from the scope of the present invention as defined by the appended claims.

What is claimed is:

1. A multilayer electronic component, comprising:
a body including a dielectric layer and internal electrodes alternately disposed with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction;
a protrusion portion disposed on the first and second surfaces; and
an external electrode disposed on the third and fourth surfaces,
wherein a width of the body in the third direction is W, a width of the protrusion portion in the third direction is W1, and W1/W is 0.5 or more and 0.85 or less.

2. The multilayer electronic component of claim 1, wherein W1/W is 0.5 or more and 0.75 or less.

3. The multilayer electronic component of claim 1, wherein a length of the body in the second direction is L, a length of the protrusion portion in the second direction is L1, and L1/L is 0.5 or more and 0.8 or less.

4. The multilayer electronic component of claim 1, wherein, in the first direction, an average thickness of the protrusion portion disposed on the second surface is T1, and T1 is 10 μm or more.

5. The multilayer electronic component of claim 1, wherein the protrusion portion and the dielectric layer include the same main component, and the main component is one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1).

6. The multilayer electronic component of claim 1, wherein the external electrode includes first and second external electrodes,
wherein a first external electrode includes a first connection portion disposed on the third surface and a first band portion extended from the first connection portion to portions of the first and second surfaces,
wherein a second external electrode includes a second connection portion disposed on the fourth surface and a second band portion extended from the second connection portion to portions of the first and second surfaces.

7. The multilayer electronic component of claim 6, wherein, in the first direction, a maximum thickness of the first band portion disposed on the second surface is Tb1, a maximum thickness of the second band portion disposed on the second surface is Tb2, and an average thickness of the protrusion portion disposed on the second surface is T1, T1≤Tb1 and T1≤Tb2 are satisfied.

8. The multilayer electronic component of claim 6, wherein, in the second direction, a length of the first band portion disposed on the second surface is BL1, a length of the second band portion disposed on the second surface is BL2, a length of the protrusion portion disposed on the second surface is L1, and a length of the body is L,
L=L1+BL1+BL2 is satisfied.

9. The multilayer electronic component of claim 1, wherein the external electrode includes an electrode layer disposed to be in contact with the body, and a plating layer disposed on the electrode layer,
wherein the electrode layer is disposed to be in direct contact with a cross-section of the protrusion portion in the first direction and second direction, and a cross-section of the protrusion portion in the second direction and third direction.

10. The multilayer electronic component of claim 9, wherein the electrode layer is disposed to cover a portion of the protrusion portion.

11. The multilayer electronic component of claim 9, wherein the electrode layer includes a conductive metal and glass.

12. The multilayer electronic component of claim 1, wherein a width in the third direction from the fifth surface to the protrusion portion is Ws1, and a width in the third direction from the sixth surface to the protrusion portion is Ws2,
Ws1≥0.075 W and Ws2≥0.075 W are satisfied.

13. The multilayer electronic component of claim 11, wherein W, Ws1, and Ws2 satisfy Ws1≥0.125 W and Ws2≥0.125 W.

14. The multilayer electronic component of claim 1, wherein the body includes:
a capacitance formation portion that includes the dielectric layer and the internal electrodes being alternately disposed in the first direction, and
a cover portion disposed on an a first portion and a second portion of the capacitance formation portion in the first direction.

15. The multilayer electronic component of claim 1, wherein a rated voltage of the multilayer electronic component is 100 V or higher.

16. The multilayer electronic component of claim 1, wherein an end of the external electrode does not overlap the protrusion portion in the first direction.

17. The multilayer electronic component of claim 6, wherein an end of the first band portion does not overlap the protrusion portion in the first direction.

18. The multilayer electronic component of claim 9, wherein an end of the plating layer does not overlap the protrusion portion in the first direction.
